(19) United States
(12) Patent Application Publication
(10) Pub. No.: US 2016/0311168 A1
(43) Pub. Date: Oct. 27, 2016

(54) Apparatus for Fused Deposition Modelling

(71) Applicant: Blacktrace Holdings Limited, Royston (GB)

(72) Inventors: Mark Gilligan, Royston (GB); Jean-Paul Delport, Bury St Edmunds (GB); Xian Chen, Royston (GB); Tom Whiteley, Royston (GB); Andrew Lovatt, Cambridge (GB)

(21) Appl. No.: 15/054,985

(22) Filed: Feb. 26, 2016

(30) Foreign Application Priority Data
Apr. 23, 2015 (GB) 1506943.8

(51) Int. Cl. B29C 67/00; B01L 3/00

(52) U.S. Cl. CPC B29C 67/0088; B29C 67/0055; B01L 3/502707; B33Y 10/00

(57) ABSTRACT

An apparatus (10) for creating a three dimensional device (100). The apparatus comprises a dispensing head (14) for dispensing material, and a base member (16) for receiving the material dispensed from the dispensing head (14). A controller (20) is provided for controlling the operation of the apparatus (10). The apparatus is operable to create the three dimensional device (100) by depositing a series of line deposits of material from the dispensing head (14) based on predetermined commands sent by the controller (20). The controller (20) is operable to control how the line deposits are dispensed to improve the sealing properties of the device (100).

### RELATED APPLICATION

This application claims priority from Great Britain Patent Application No. 1506943.8 filed on Apr. 23, 2015, the contents of which are incorporated herein by reference in its entirety.

### BACKGROUND OF THE INVENTION

The present invention relates to an apparatus for fused deposition modeling (FDM).

FDM is an additive manufacturing technology commonly used for modeling, prototyping, and production applications. Additive manufacturing is also referred to as 3D-printing.

FDM begins with a software process which processes a 3D CAD file, mathematically orienting and slicing the model for the build process. The next step is to take the sliced model and create tool paths and build process that builds a part with the desired properties. The model or part is produced by extruding a small bead of material along the tool path to form layers as the material hardens immediately after extrusion from the nozzle. Typically FDM machines include a plastic filament or metal wire which is unwound from a coil and is fed to an extrusion nozzle via drive rollers (or similar) at a controlled rate. Filament is not always used and in some instances beads or pellets are fed into the nozzle. The material is heated inside the nozzle to a semi-liquid state and is then extruded through the exit of the nozzle and deposited onto the part.

The nozzle can be moved in both horizontal and vertical directions by a numerically controlled mechanism. The nozzle follows a tool-path controlled by a computer-aided manufacturing (CAM) software package, and the part is built from the bottom up, one layer at a time.

One of the limitations of building up the material one layer at a time is that it is not possible to produce features which are unsupported by material on the previous layer. This means that is it not possible to have large overhangs of material, although small overhangs with limited slope are possible.

U.S. Pat. No. 5,121,329 describes in more detail the principles behind FDM.

Previous attempts to fabricate fluidic devices using FDM have had limited success. This is because the beads of material extruded and deposited by a FDM nozzle typically have a circular or near circular cross section and this results in gaps between neighbouring bead deposits in the device. These gaps form leak paths and when a fluid is pumped into the device a significant amount of the fluid will fill these gaps and leak out of the device. This invention resolves the issue of leak paths and enables the manufacture of sealed fluidic devices.

FDM has the potential to provide significant benefits for the manufacture of fluidic devices, including the potential to fabricate devices in a wide range of materials, primarily polymers. This is potentially extremely useful in the research, development and manufacture of fluidic devices. One example is the development of devices for point of care diagnostic testing. In this area of R&D it would be very useful to manufacture a broad range of fluid features including fluidic channels, channel networks, fluid reservoirs, fluid splitting junctions, fluid merging junctions, passive mixer structures, fluid connection ports, valve geometries, and flow cells. It would also be useful to change the material that the device is fabricated from.

Many commercially available FDM machines use ABS polymer, however it has been found that it is possible to use a wide range of polymers including polypropylene, cyclic olefin copolymer (COC), polycarbonate, polystyrene, as examples. Being able to quickly manufacture in different materials is particularly useful in diagnostic or biological applications where there can be complex interactions between the fluids and the wetted surfaces. For example protein binding to polymer surfaces can be undesirable for the analysis biological samples. By trying different build polymers it would be possible to find a material that has low binding properties for a particular protein. In addition different polymers have different chemical resistance, optical, thermal and mechanical properties which again can be optimised by changing the build material.

A specific example of such a device is a sensor for measuring glucose levels in a patient's blood stream. The device would typically include a port for injection of a blood sample, a fluidic channel where dried electrolytes are dissolved into the blood sample and an interface to the electrochemical sensor, which allows the sample to be brought into contact with the sensor. The final device may include some extra components such as gaskets and adhesive layers but the basic fluid structure would be fabricated using FDM. Once a suitable material and geometry has been found for the fluidic structure it would be possible to manufacture devices in medium volume by FDM.

This invention is primarily focused on fluidic devices with features as described with a scale range from microfluidic channels with features sizes of 10 μm-1 mm (more typically 50 μm-1 mm) up to millimetre (milli-fluidic) scale devices with features sizes in the 1 mm-100 mm range. It is possible to also conceive of larger fluidic devices in the >100 mm range, for example pipework and vessels for chemical and biological reactors.

Traditional prototyping methods for fluidic devices have various drawbacks. For example stereolithography is limited to a narrow range of photo curable materials and there are also limitations around the length and cross sections of fluid channels that can be fabricated. In addition stereolithography suffers from slow build times which result in high manufacturing costs. Fluidic devices are often fabricated by CNC milling a channel network and then capping the channels with a sealing layer. The main disadvantage of this approach is that attaching the sealing layer is not a straightforward process and sealing processes such as laser welding often place limitations on the materials that can be used and the geometries that can be achieved.

### SUMMARY OF THE INVENTION

According to a first aspect of the present invention there is provided an apparatus for creating a three dimensional fluidic device containing at least one fluid channel, the apparatus comprising:

a dispensing head comprising a passage for receiving a supply of material, and comprising a dispensing orifice at one end of the passage;

a base member for receiving the material dispensed from the orifice of the dispensing head;

an actuator means for moving the dispensing head relative to the base member; and

a controller for sending a set of predetermined commands to each of the actuator means and the dispensing head;

wherein the apparatus is operable to create the fluidic device by depositing a series of sequential layers of material from the dispensing head onto the base member, each layer formed of a series of adjacent line deposits of material, based on the predetermined commands sent by the controller to the actuator means and the dispensing head,

wherein the apparatus is operable to overlap the line deposits to reduce leakage paths between the line deposits to improve the sealing properties of the at least one fluid channel in the fluidic device.

The predetermined commands from the controller may include instructing the apparatus to:

dispense a closed loop of material forming a portion of the perimeter wall of a fluid channel in the fluidic device in at least one of the layers of material, wherein the two ends of the closed loop of material overlap.

The predetermined commands from the controller may include instructing the apparatus to dispense:

a plurality of deposits of material forming a bottom portion of a perimeter wall of a fluid channel in the fluidic device in at least one of the layers of material;

wherein the plurality of deposits of material are substantially parallel to the direction of fluid flow along the fluid channel when the fluid channel is in use.

The predetermined commands from the controller may include instructing the apparatus to dispense:

a first line deposit of material having a first pitch forming a first portion of a perimeter wall of a fluid channel in the fluidic device in at least one of the layers of material; and

a second line deposit of material, which is located in the layer sequential to the layer containing the first line deposit, onto the line first deposit forming a second portion of the perimeter wall of the fluid channel in the fluidic device;

wherein the second line deposit of material is laterally offset from the first line deposit of material, and overhangs into the fluid channel.

The predetermined commands from the controller may include instructing the apparatus to dispense:

a first line deposit of material forming a portion of a perimeter wall of a first transverse fluid channel in the fluidic device in at least one of the multiple layers of material; and

a second line deposit of material which neighbours the first deposit of material in the at least one of the multiple layers of material, and which forms a portion of a perimeter wall of a second fluid channel in fluid communication with, and substantially perpendicular to, the first transverse fluid channel; and

wherein the first line deposit and the second line deposit overlap at the interface of the first and second line deposits of material.

The predetermined commands from the controller may include instructing the apparatus to dispense:

a first line deposit of material forming a side wall of a fluid channel in the fluidic device in at least one of the multiple layers of material;

a second line deposit of material, which is located in the layer sequential to the layer containing the first deposit, onto the first deposit forming a top wall of the fluid channel in the fluidic device, wherein the second line deposit of material extends transversely across the width of the fluid channel;

a third line deposit of material, which is located in the same layer as the layer containing the second line deposit of material, wherein the third line deposit of material is adjacent to the second line deposit of material; and

a fourth line deposit of material, which is located in the layer sequential to the layer containing the second and third deposits, onto the top wall;

wherein the first, third and fourth deposits extend in a direction parallel to the length of the fluid channel.

According to a second aspect of the present invention there is provided an apparatus for creating a three dimensional device, the apparatus comprising:

a dispensing head comprising a passage for receiving a supply of material, and comprising a dispensing orifice having a central axis at one end of the passage;

a base member for receiving the material dispensed from the orifice of the dispensing head;

an actuator means for moving the dispensing head relative to the base member; and

a controller for sending a set of predetermined commands based on pattern data derived from the required structure of the three dimensional device to each of the actuator means and the dispensing head;

wherein the apparatus is operable to create the device by depositing a series of sequential layers of material from the dispensing head onto the base member, each layer formed of a series of adjacent line deposits of material, based on the predetermined commands sent by the controller to the actuator means and the dispensing head,

wherein, for a line deposit of material in a region where the pattern data requires an abrupt change of direction of the line deposit, the controller is operable to instruct the apparatus to move the dispensing head in this region along an arcuate path.

The controller may be operable to move the central axis of the dispensing orifice along the arcuate path.

The arcuate path may have a radius of curvature of between 10%-200% of the maximum width of the line deposit. In some embodiments, the lower end of the above percentage range may represent a larger percentage, and may be 20%, 25%, 30%, 40% or 50%. The upper end of this percentage range may represent a smaller percentage, and may be 180%, 150%, 120% or 100%.

The arcuate path may have a radius of curvature of between 20%-400% of the maximum depth of the line deposit. In some embodiments, the lower end of the above percentage range may represent a larger percentage, and may be 25%, 30%, 40% or 50%. The upper end of this percentage range may represent a smaller percentage and may be 350%, 300%, 250%, 200%, 150% or 100%.

The arcuate path may have a radius of curvature of between 0.1 mm-0.4 mm.

The first aspect of the present invention also provides a method for creating a three dimensional fluidic device containing at least one fluid channel using an apparatus comprising:

a dispensing head comprising a passage for receiving a supply of material, and comprising a dispensing orifice at one end of the passage;

a base member for receiving the material dispensed from the orifice of the dispensing head;

an actuator means for moving the dispensing head relative to the base member; and

a controller for sending a set of predetermined commands to each of the actuator means and the dispensing head;

wherein the method comprises depositing a series of sequential layers of material from the dispensing head onto the base member, each layer formed of a series of adjacent line deposits of material, based on the predetermined commands sent by the controller to the actuator means and the dispensing head,

wherein the method also comprises overlapping the line deposits to reduce leakage paths between the line deposits to improve the sealing properties of the at least one fluid channel in the fluidic device.

The second aspect of the present invention also provides a method for creating a three dimensional device using an apparatus comprising:

a dispensing head comprising a passage for receiving a supply of material, and comprising a dispensing orifice having a central axis at one end of the passage;

a base member for receiving the material dispensed from the orifice of the dispensing head;

an actuator means for moving the dispensing head relative to the base member; and

a controller for sending a set of predetermined commands to each of the actuator means and the dispensing head based on pattern data derived from the required structure of the three dimensional device;

wherein the method comprises depositing a series of sequential layers of material from the dispensing head onto the base member, each layer formed of a series of adjacent line deposits of material, based on the predetermined commands sent by the controller to the actuator means and the dispensing head,

wherein the method also comprises, for a line deposit of material in a region where the pattern data requires an abrupt change of direction of the line deposit, moving the dispensing head in this region along an arcuate path.

### BRIEF DESCRIPTION OF THE FIGURES

The invention will now be described with reference to the accompanying Figures in which:

FIG. 1 shows a perspective view of a machine for fused deposition modeling.

FIG. 2A shows a plan view of a microfluidic device created using the machine of FIG. 1;

FIG. 2B shows a right end view of the microfluidic device shown in FIG. 2A; and

FIG. 2C shows a bottom end view of the microfluidic device shown in FIG. 2A.

FIG. 3 shows an exploded view of various slices of the device shown in FIGS. 2A-2C. For each slice, a plan view is also shown in the Figure.

FIGS. 4A and 4B each shows a dispensing path of a prior art tool path for creating a closed loop of material for a fluid channel;

FIGS. 4C-4E each shows a dispensing path of a different tool path for creating a closed loop of material for a fluid channel;

FIG. 4F shows a section view of the closed loop of material of FIG. 4A; and

FIG. 4G shows a section view of the closed loop of material of FIGS. 4C-4E.

FIG. 5A shows a cross-section view of a portion of the device shown in FIGS. 2A-2C. FIG. 5A also shows plan views of the layers shown in the cross-section view; and

FIG. 5B shows a cross-section view of an alternative design to the design shown in FIG. 5A.

FIG. 6A shows a plan view of a slice of the device shown in FIGS. 2A-2C;

FIG. 6B shows a plan view of a neighbouring slice to the slice shown in FIG. 6A;

FIG. 6C shows a plan view of the dotted region of the slice shown in FIG. 6B;

FIG. 6D shows a first section view of the dotted region of the device shown in FIG. 6B; and

FIG. 6E shows a second section view of the dotted region of the device shown in FIG. 6B.

FIG. 7A shows a photograph of a deposit created by a tool following a first vector path; and

FIG. 7B shows a photograph of a deposit created by a tool following a second vector path.

### DETAILED DESCRIPTION

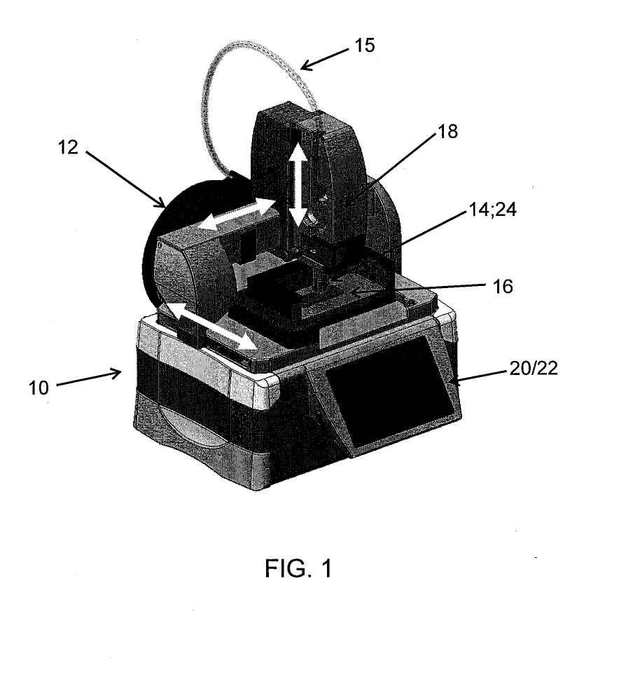

With reference to FIG. 1, there is shown a FDM machine 10. The machine comprises a reel of material 12 which is fed into a robotic head 14 via a flexible tube 15. Material from the head 14 is dispensed onto a base member 16 of the machine 10.

A heater is located in the robotic head 14 for heating the material passing through the head beyond the material's glass transition temperature prior to it being dispensed.

The robotic head 14 can move relative to the base member 16 along a three dimensional Cartesian coordinate system. Movement of the robotic head 14 is controlled by an actuator means 18 located on the machine 10.

The base member 16 is preferably in the form of a flat plate and acts as the base plate onto which heated material dispensed from the robotic head 14 is deposited.

A controller 20 is located on the machine which controls the operation of the head 14 and the actuator means 18. A user interface 22 is connected to the controller to allow user control of the machine 10.

To make the machine 10 suitable for creating fluidic devices, the robotic head 14 comprises a dispensing orifice 24 through which material is dispensed which has a variable diameter of between 0.1 mm-1.0 mm.

Smaller diameters than this may be used depending on the size of the smallest features from the fluidic device being manufactured.

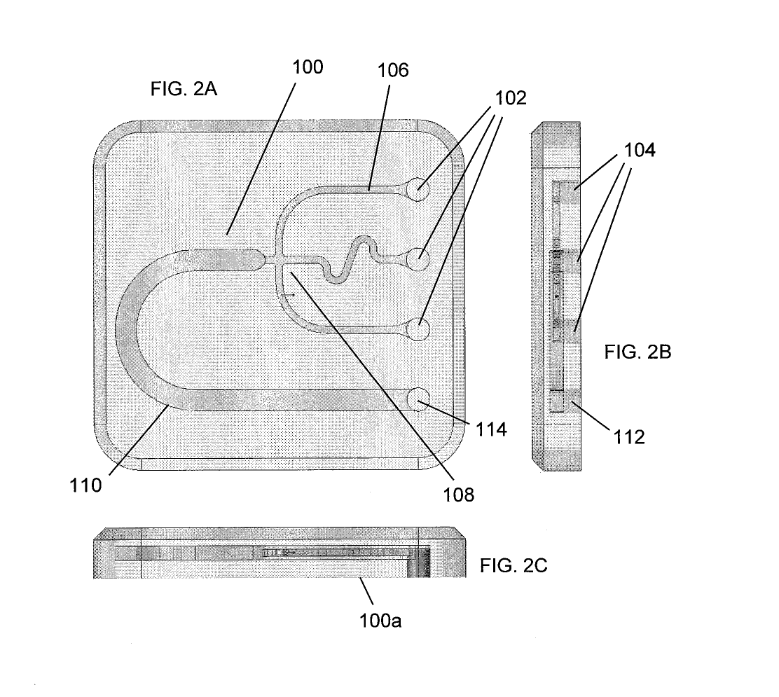

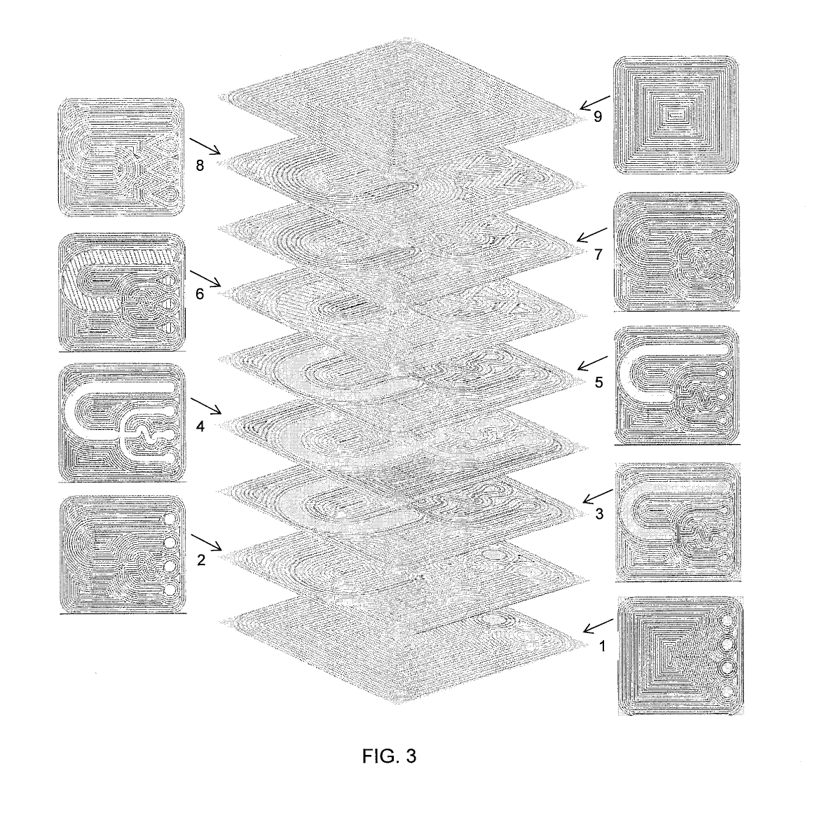

An example of a microfluidic device created using the apparatus shown in FIG. 1 is shown in FIGS. 2A-2C and FIG. 3. The device shown in these Figures comprises a block 100 of material in which are located three fluid inlet ports 102. Each fluid inlet port 102 defines a vertical channel 104 which extends from the bottom surface 100a of the block up into the thickness of the block 100. Each vertical channel 104 is fluidly connected to a respective horizontal fluid channel 106. The three horizontal channels 106 extend through a portion of the thickness of the block 100 and meet at a mixing point 108. An outlet fluid channel 110 radiates from the mixing point 108 and extends through the block where it terminates at an exit channel 112. The exit channel 112 extends vertically through the thickness of the block to a fluid outlet port 114 located on the bottom surface 100a of the block 100.

Block 100 is created by sequentially depositing multiple layers of material from the dispensing head 14 onto the base member 16 based on predetermined commands sent by the controller to the actuator means and the dispensing head. In each layer, as shown in FIG. 3, the head 14 is moved across the base member 16 and material is deposited from the head 14 to create a series of linear deposits 200 of material which together define the features of the microfluidic device in that layer.

The device shown in FIG. 3 is approximately 16 mm long; 15 mm wide; and 2 mm thick. Each inlet port 102 has a diameter of approximately 1000 μm, and each of the three horizontal channels 106 has an inner diameter of approximately 400 μm wide×200 μm deep.

In light of the micro-size of these channels, there is the possibility of leakage between each of the linear deposits deposited by the head 14.

To minimise the extent of such leakage, the predetermined commands issued by the controller are carefully controlled.

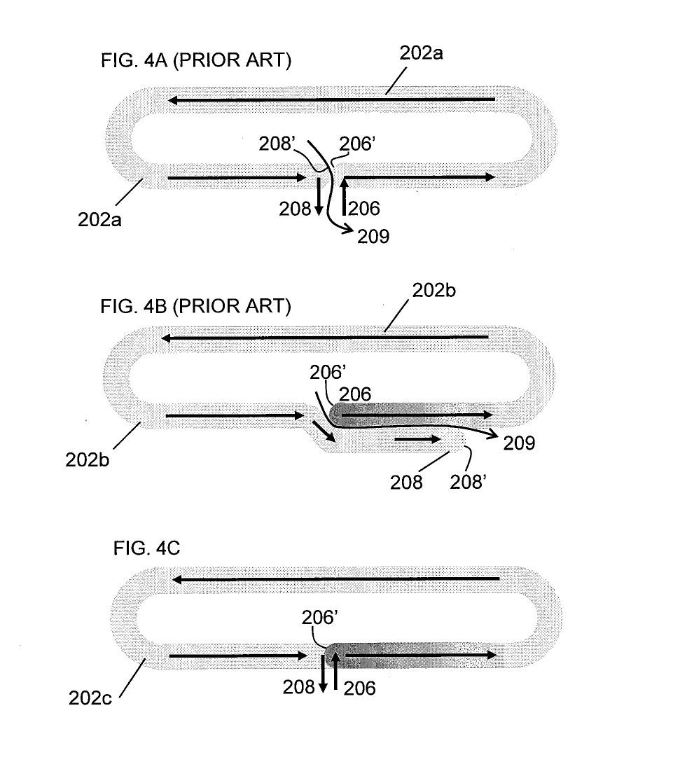

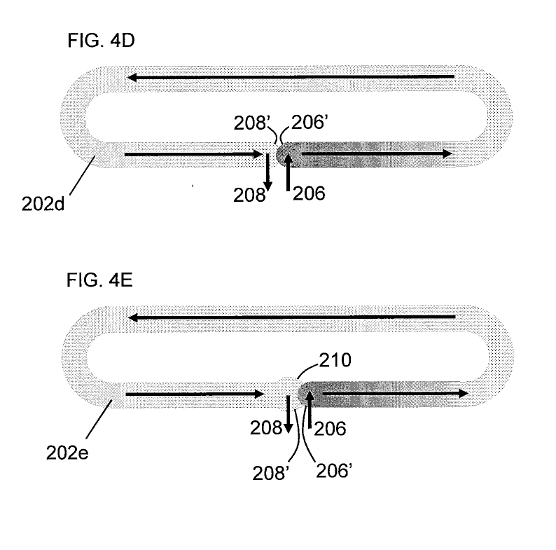

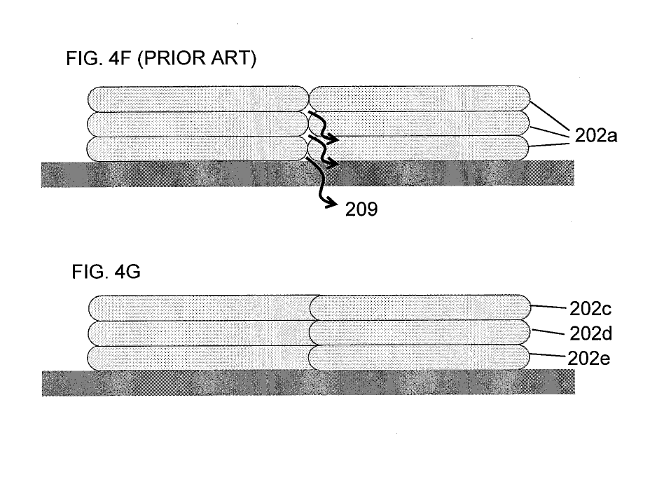

In one embodiment, the apparatus is configured to minimise leakage between each of the linear deposits 200 deposited by the head 14 as shown in FIGS. 4C-4E. In FIGS. 4A-4E, there are shown closed loops of material 202a-202e which each form a portion of the perimeter wall of a fluid channel in the microfluidic device.

In the prior art operation of FIG. 4A, the material 202a is deposited from a beginning position 206 with a curved end 206′ and around in a loop to an end position 208 with a curved end 208′ which abuts the curved end 206′ of the beginning position 206. In this way, no overlap of material is created in the deposited layer in the space between the curved ends 206′;208′ of the beginning and end positions 206;208. Due to the slight separation between the curved ends 206′;208′ of the beginning and end positions 206;208, a leakage path 209 is created which allows fluid to escape between these two portions of the deposited loop of material 202a. A section view of the closed loop of material 202a, and leakage path 209, is shown in FIG. 4F.

In FIG. 4B, which also shows a prior art operation, once the head 14 reaches the end position 208, the head 14 continues to deposit the layer around the outside of the closed loop of material 202b. In this operation, the curved ends 206′;208′ also do not overlap and a leakage path 209 is still present as shown in FIG. 4B between the sides of the beginning and end positions 206;208 which allows fluid to escape from the closed loop of material 202b.

In FIG. 4C, the material 202c is also deposited from a beginning position 206 and around in a loop to an end position 208. However, in this operation, the curved end 206′ of the beginning position 206 is located beyond the curved end 208′ of the end position 208 such that there is an overlap of material deposited in the vicinity of these two positions 206;208 which prevents the leakage path as present in FIGS. 4A and 4B from forming. Due to the overlap of the two curved ends 206′;208′, to prevent an excess of material building up, the deposited material dispensed from the dispensing head in the beginning and end portions of the closed loop of material 202b is carefully controlled so that the total thickness of the layer is uniform. The control of the dispensed deposited material can be achieved by varying the velocity of the dispensing head, or by changing the feed rate of material to the dispensing head 14, in this area.

FIG. 4D shows a similar tool path to FIG. 4C except that the curved end 208′ of the end position 208 does not extend as far beyond the curved end 206′ of the beginning position 206.

In the operation as shown in FIG. 4E, material is also deposited from a beginning position 206 and around in a loop to an end position 208. In this operation however, the beginning position 206 is located just short of the end position 208. To prevent leakage in this operation, additional material 210 is deposited at the beginning and/or end position 208 which flows to bridge the gap between the beginning and end positions 206;208 to thereby create an overlap of the curved ends 206′;208′ of the two positions 206;208 to prevent the leakage path 209. In this operation, the overlap can be created by decreasing the velocity of the dispensing head, or by increasing the feed rate of material to the dispensing head 14, in the beginning and/or end positions 206;208 to ensure sufficient material flows to bridge the gap.

A section view of the closed loops of material 202c-202e from FIGS. 4C-4E, which do not contain the leakage path 209, is shown in FIG. 4G.

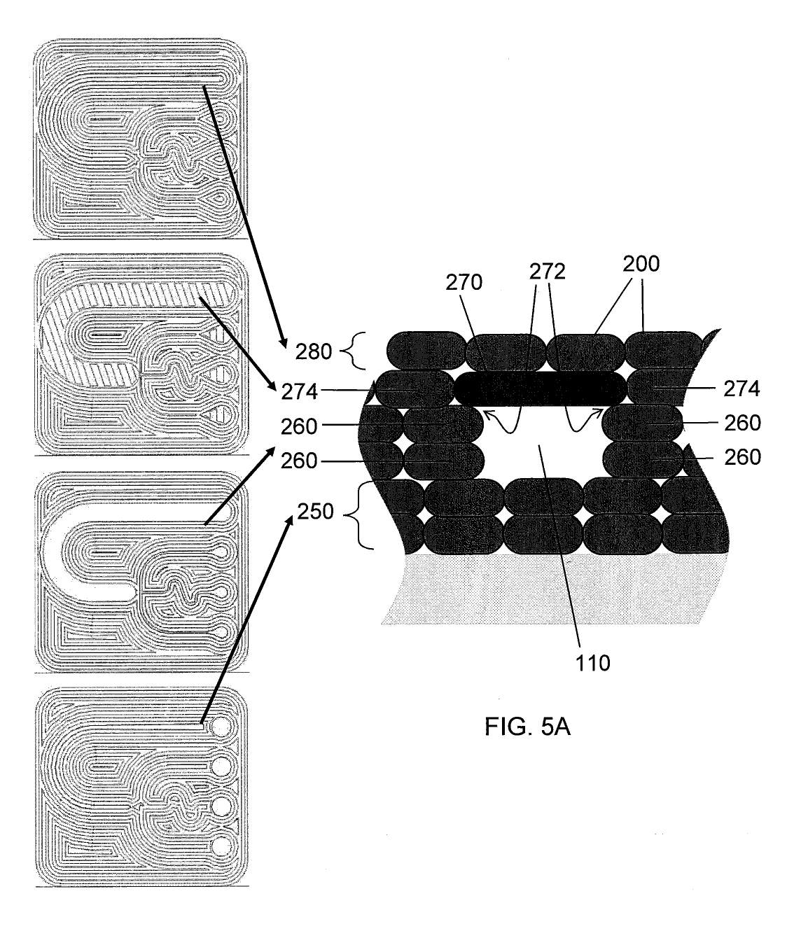

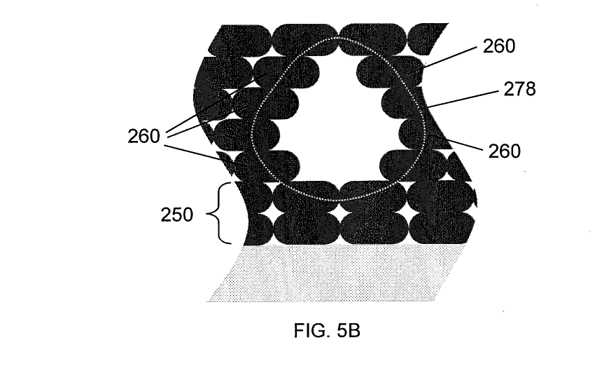

Another improvement for reducing leakage in microfluidic devices created using FDM is shown in FIG. 5A. The cross-section view of FIG. 5A is taken through a section of the outlet fluid channel 110. The outlet fluid channel 110 is formed of a series of linear deposits 200. The bottom of the channel 110 is formed of a series of parallel deposits 250 which are largely parallel to the direction of fluid flow along the fluid channel 110 when the channel is in use. The side wall of the channel 110 is formed of another series of deposits 260 which are largely parallel to the deposits 250 making up the bottom of the channel 110. The top surface of the channel is created by a deposit 270 which snakes in an alternating fashion as a series of abutting line portions which extend across the topmost deposit from the parallel deposits 260. Deposits 274 which are largely parallel to the deposits 250;260 are located on both sides of the snaking deposit 270.

To support the snaking deposit 270 as much as possible, the snaking deposit 270 extends along the width, and at an angle to rather than along the length, of the channel 110. In this way, the snaking deposit 270 is located at a different orientation to each of the deposits 250;260 making up the bottom and sides of the channel 110.

At the interface 272 of the topmost side deposit 260 and the snaking deposit 270, which are located at different orientations, there is a potential leak path due to the mismatch in layer orientations.

Conventionally, layers above the snaking deposit 270 would be deposited in a similar orientation/pattern to the snaking layer 270. However, FIG. 5A shows an improved configuration with reduced leakage whereby the layers 280 above the snaking deposit 270 are deposited in a similar orientation to the deposits 250;260 making up the bottom and sides of the channel 110, and also deposits 274.

An alternative to using a snaking deposit 270 as the top surface of the channel is shown in FIG. 5B. As shown in this Figure, some of the deposits 260 making up the sidewall of the channel 110 each partially overhang the deposit 260 on which it is deposited. The degree by which each of these deposits 260 overhangs depend on numerous factors, such as the rate of deposition of material, and also the properties of the material being deposited. In FIG. 5B, each of the overhanging deposits 260 overhangs by approximately 30% of their width. The overhang percentage may be more than this however, for instance 50%. By overhanging the deposits in this way, the top of the channel 110 can be created without the need for a snaking deposit 270.

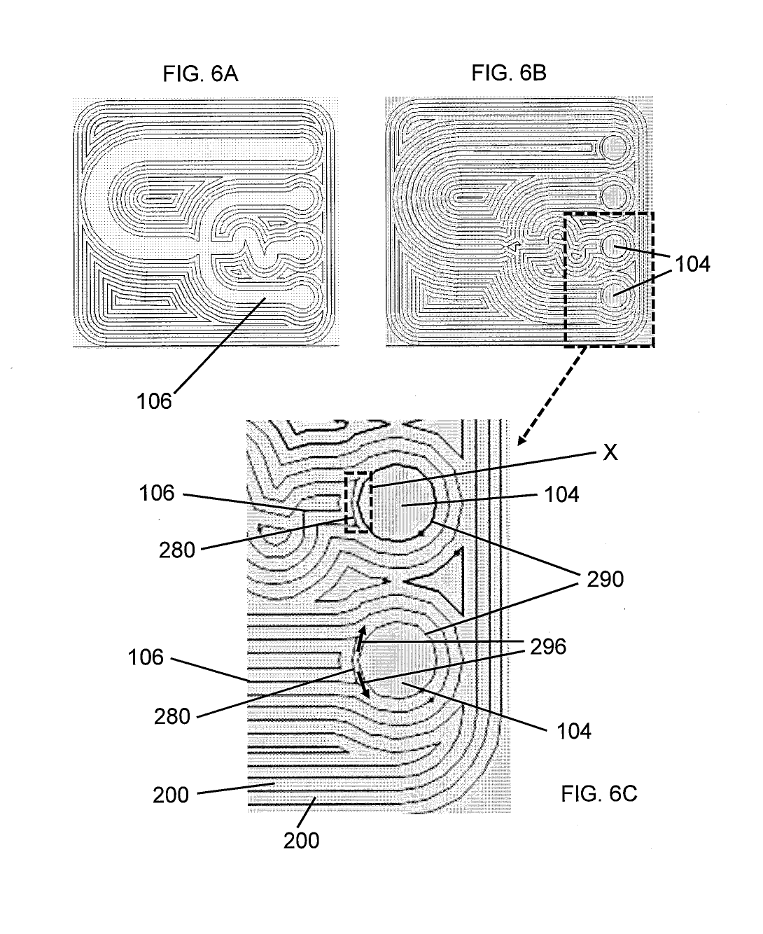

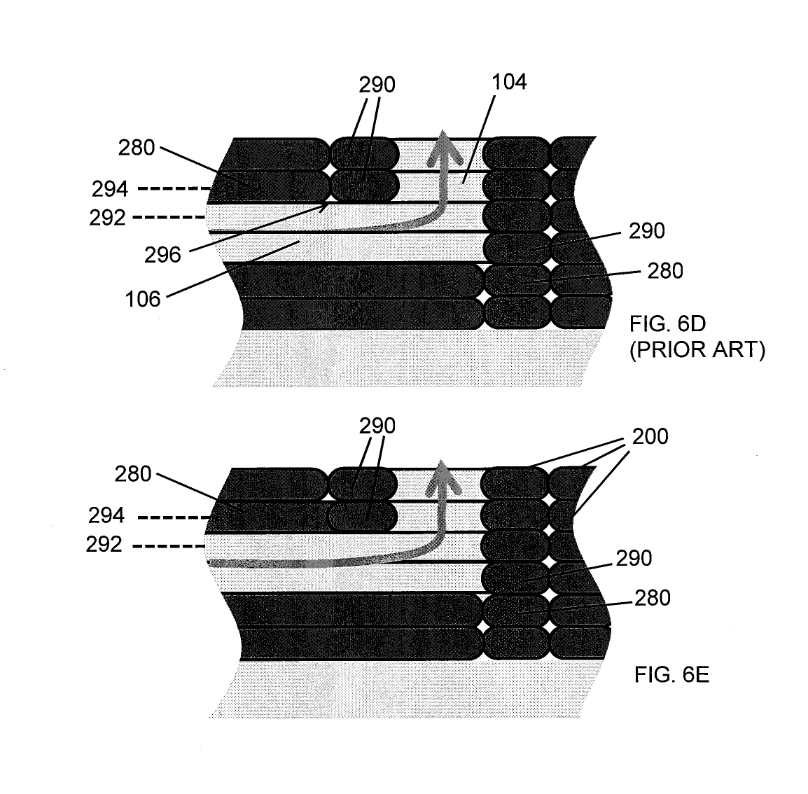

Another improvement for reducing leakage between a horizontal channel and a vertical channel in microfluidic devices created using FDM is shown in FIGS. 6A-6E. These Figures focus on the particular interface between one of the horizontal fluid channels 106 and its respective vertical channel 104 in the device 100.

FIGS. 6D and 6E each shows a section view of a portion of the dotted region of the device shown in FIG. 6B. In each of FIGS. 6D and 6E, there is shown a series of linear deposits 280 defining the base of the horizontal channel 106 and a series of different deposits 290 making up the wall of the vertical channel 104.

The plan view of FIG. 6A represents a first deposit layer 292 shown in FIGS. 6D and 6E, whilst the plan view of FIG. 6B represents a second deposit layer 294 (also shown in FIGS. 6D and 6E) that is adjacent to the first deposit layer 292.

In the second deposit layer 294, in conventional FDM deposition techniques, as shown in FIG. 6D, a leak path 296 is created at the interface of the deposits 280;290 making up the respective walls of the horizontal and vertical channels 106;104.

FIG. 6E shows an improvement to the prior art deposition technique shown in FIG. 6D. In this embodiment, at the interface of the deposits 280;290 making up the respective walls of the horizontal and vertical channels 106;104, the pitch between the deposits 280;290 is reduced such that the two deposits overlap 280;290 along their length to plug the leakage path 296. The overlapping region where the reduction in pitch is present between the two deposits 280;290 is shown in the dotted region X of FIG. 6C. The overlap is created using any of the techniques used to create the overlaps described in relation to FIG. 4C-4E (the beginning and end positions 206;208 as described in FIGS. 4C-4E are the interfacing portions of the deposits 280;290 which overlap as shown from FIGS. 6C and 6E).

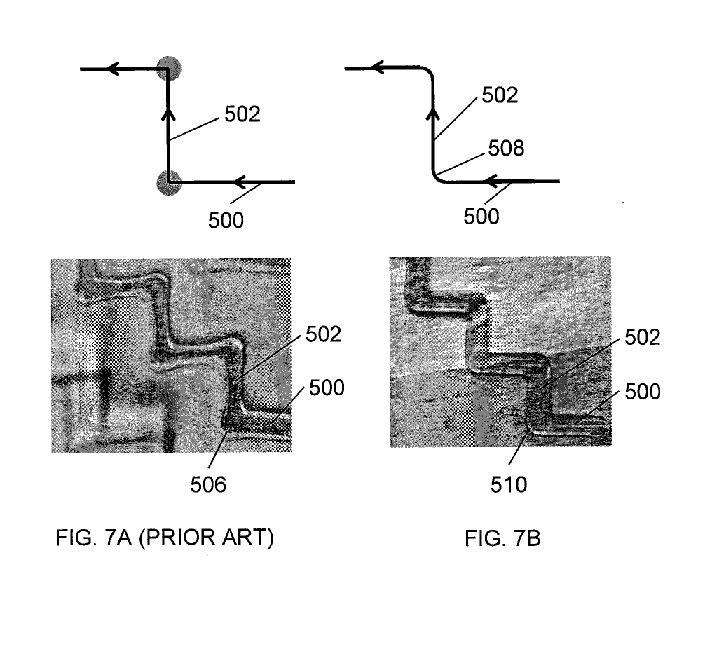

An improvement to creating sharp corners in FDM is shown in FIGS. 7A and 7B. Conventionally, as shown in FIG. 7A, to create a sharp corner using FDM the dispensing head 14 is configured to dispense material along a first vector 500 representative of a first edge of the item being created. Once the head 14 reaches the sharp corner of the item being created, the dispensing head pauses and then moves along a second vector 502 representative of another edge of the item being created.

Due to the sudden change in direction, and pause, of the dispensing head 14 between the two vectors 500;502, an excess of material is dispensed by the head 14 at the corner between these two vectors 502;504, thus resulting in a bulged corner 506 as shown in the photograph of FIG. 7A.

To obviate the formation of the bulge 506, the dispensing head 14 is configured to follow an arcuate path 508 between the two vectors 502;504. By dispensing material along this arcuate path, no sudden changes in direction and/or pauses occur between these two vectors. This results in a sharper corner 510 with no bulge as shown in FIG. 7B.

The radius of curvature of the arcuate path may be dependent on the height or the width of the deposited material along vectors 502;504. Preferably, the radius of curvature is between 10%-200% of the width or 20%-400% of the depth of the line deposit, though narrower percentage ranges are also possible. The radius of curvature of the arcuate path may alternatively be a fixed amount, for instance between 0.1 mm-0.4 mm.

In an alternative embodiment, the formation of the bulge 506 is reduced by decreasing the flow rate of material dispensed from the dispensing head in the region of the corner.

Although the above improvements have been described in relation to the particular geometry of microfluidic device shown in the Figures, it will be appreciated that the deposition techniques herein described could be applied to any other device with different geometry.

1. An apparatus for creating a three dimensional fluidic device containing at least one fluid channel, the apparatus comprising:
a dispensing head comprising a passage for receiving a supply of material, and comprising a dispensing orifice at one end of the passage;
a base member for receiving the material dispensed from the orifice of the dispensing head;
an actuator for moving the dispensing head relative to the base member; and
a controller for sending a set of predetermined commands to each of the actuator and the dispensing head;
wherein the apparatus is operable to create the fluidic device by depositing a series of sequential layers of material from the dispensing head onto the base member, each layer formed of a series of adjacent line deposits of material, based on the predetermined commands sent by the controller to the actuator and the dispensing head,
wherein the apparatus is operable to overlap the line deposits to reduce leakage paths between the line deposits to improve the sealing properties of the at least one fluid channel in the fluidic device.

2. An apparatus according to claim 1, wherein the predetermined commands from the controller include instructing the apparatus to:
dispense a closed loop of material forming a portion of a perimeter wall of the at least one fluid channel in the fluidic device in at least one of the layers of material, wherein two ends of the closed loop of material overlap.

3. An apparatus according to claim 1, wherein the predetermined commands from the controller include instructing the apparatus to dispense:
a plurality of deposits of material forming a bottom portion of a perimeter wall of the at least one fluid channel in the fluidic device in at least one of the layers of material;
wherein the plurality of deposits of material are substantially parallel to a direction of fluid flow along the fluid channel when the fluid channel is in use.

4. An apparatus according to claim 1, wherein the predetermined commands from the controller include instructing the apparatus to dispense:
a first line deposit of material having a first pitch forming a first portion of a perimeter wall of the at least one fluid channel in the fluidic device in at least one of the layers of material; and
a second line deposit of material, which is located in the layer sequential to the layer containing the first line deposit, onto the line first deposit forming a second portion of the perimeter wall of the at least one fluid channel in the fluidic device;
wherein the second line deposit of material is laterally offset from the first line deposit of material, and overhangs into the fluid channel.

5. An apparatus according to claim 1, wherein the predetermined commands from the controller include instructing the apparatus to dispense:
a first line deposit of material forming a portion of a perimeter wall of a first transverse fluid channel in the fluidic device in at least one of the multiple layers of material; and
a second line deposit of material which neighbors the first deposit of material in the at least one of the multiple layers of material, and which forms a portion of a perimeter wall of a second fluid channel in fluid communication with, and substantially perpendicular to, the first transverse fluid channel; and
wherein the first line deposit and the second line deposit overlap at the interface of the first and second line deposits of material.

6. An apparatus according to claim 1, wherein the predetermined commands from the controller include instructing the apparatus to dispense:
a first line deposit of material forming a side wall of a first fluid channel of the at least one fluid channel in the fluidic device in at least one of the multiple layers of material;
a second line deposit of material, which is located in the layer sequential to the layer containing the first deposit, onto the first deposit forming a top wall of the first fluid channel in the fluidic device, wherein the second line deposit of material extends transversely across the width of the first fluid channel;
a third line deposit of material, which is located in the same layer as the layer containing the second line deposit of material, wherein the third line deposit of material is adjacent to the second line deposit of material; and
a fourth line deposit of material, which is located in the layer sequential to the layer containing the second and third deposits, onto the top wall;
wherein the first, third and fourth deposits extend in a direction parallel to a length of the fluid channel.

7. An apparatus for creating a three dimensional device, the apparatus comprising:
a dispensing head comprising a passage for receiving a supply of material, and comprising a dispensing orifice having a central axis at one end of the passage;
a base member for receiving the material dispensed from the orifice of the dispensing head;
an actuator for moving the dispensing head relative to the base member; and
a controller for sending a set of predetermined commands to each of the actuator and the dispensing head based on pattern data derived from the required structure of the three dimensional device;
wherein the apparatus is operable to create the device by depositing a series of sequential layers of material from the dispensing head onto the base member, each layer formed of a series of adjacent line deposits of material, based on the predetermined commands sent by the controller to the actuator and the dispensing head,
wherein, for a line deposit of material in a region where the pattern data requires an abrupt change of direction of the line deposit, and wherein the controller is operable to instruct the apparatus to move the dispensing head in this region along an arcuate path.

8. An apparatus according to claim 7, wherein the controller is operable to move the central axis of the dispensing orifice along the arcuate path.

9. An apparatus according to claim 8, wherein the arcuate path has a radius of curvature of between 10%-200% of a maximum width of the line deposit.

10. An apparatus according to claim 8, wherein the arcuate path has a radius of curvature of between 20%-400% of a maximum depth of the line deposit.

11. An apparatus according to claim 8, wherein the arcuate path has a radius of curvature of between 0.1 mm-0.4 mm.

12. A method for creating a three dimensional fluidic device containing at least one fluid channel using an apparatus comprising:
a dispensing head comprising a passage for receiving a supply of material, and comprising a dispensing orifice at one end of the passage;
a base member for receiving the material dispensed from the orifice of the dispensing head;
an actuator for moving the dispensing head relative to the base member; and
a controller for sending a set of predetermined commands to each of the actuator and the dispensing head;
wherein the method comprises depositing a series of sequential layers of material from the dispensing head onto the base member, each layer formed of a series of adjacent line deposits of material, based on the predetermined commands sent by the controller to the actuator and the dispensing head,
wherein the method also comprises overlapping the line deposits to reduce leakage paths between the line deposits to improve the sealing properties of the at least one fluid channel in the fluidic device.

13. A method for creating a three dimensional device using an apparatus comprising:
a dispensing head comprising a passage for receiving a supply of material, and comprising a dispensing orifice having a central axis at one end of the passage;
a base member for receiving the material dispensed from the orifice of the dispensing head;
an actuator for moving the dispensing head relative to the base member; and
a controller for sending a set of predetermined commands to each of the actuator and the dispensing head based on pattern data derived from the required structure of the three dimensional device;
wherein the method comprises depositing a series of sequential layers of material from the dispensing head onto the base member, each layer formed of a series of adjacent line deposits of material, based on the predetermined commands sent by the controller to the actuator and the dispensing head,
wherein, for a line deposit of material in a region where the pattern data requires an abrupt change of direction of the line deposit, the method comprises moving the dispensing head in this region along an arcuate path.

14. A device manufactured using the apparatus of claim 1.

15. A device manufactured using the method according to claim 12.
